(19) United States
(12) Patent Application Publication
(10) Pub. No.: US 2013/0201664 A1
(43) Pub. Date: Aug. 8, 2013

(54) Portable LED Lighting Helmet To Illuminate a Cyclist Or A Subject While Riding Or Otherwise in Motion

(71) Applicant: Hooshmand Harooni, Los Angeles, CA (US)

(72) Inventor: Hooshmand Harooni, Los Angeles, CA (US)

(21) Appl. No.: 13/368,038

(22) Filed: Feb. 7, 2012

(51) Int. Cl. F21V 21/084

(52) U.S. Cl. 362/106

(57) ABSTRACT

This invention describes a “Portable LED Lighting Helmet To Illuminate A Cyclist Or A Subject While Riding Or Otherwise In Motion”. This Portable LED lighting Apparatus in this application describes one embodiment where a partial ring of LED lights integrated into a bicycle helmet serve to illuminate the bicycle rider while the rider is in motion. Unlike other portable lighting helmet devices the illumination is directed downwards at the rider and the cyclist in motion rather than ahead or behind the rider in order to solve the depth perception and clarity problem in viewing riders in low light conditions. In another embodiment, this invention provides for a detachable portable LED lighting strip to achieve the same purpose.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### SUMMARY OF THE INVENTION

The proper and bright illumination of cyclists, motorcycle riders, and even human subjects out walking under low light or night time conditions has been a problem for which many solutions have been offered. In the case of cyclists, many ideas, both patented and not, have been put forth to solve the problem. There have been bicycle helmets designed with integrated lighting accessories, helmets with luminescent strips or luminescent paint on the exterior, portable lighting attachments that attach to existing helmets, and even creative ideas such as elastic attachments that allow riders to attach small, portable flashlights temporarily to existing riding helmets.

All of these variations attempts to provide one benefit—to illuminate the area in front of or behind a rider so as to provide visibility and illumination in the direction the rider is traveling, and to allow for illumination behind for approaching vehicles or other subjects or riders. These variations suffer from a common theme which is that it is often difficult in low light or nighttime conditions to properly gauge the distance to the cyclist while one is traveling towards the subject. The subject of this invention, the “Portable LED Lighting Helmet To Illuminate A Cyclist Or A Subject While Riding Or Otherwise In Motion” solves this problem in a different manner, by providing a light source that directly illuminates the bicycle rider, the bicycle itself, and the ground below as the rider is in motion. In this manner the illumination serves to brightly identify the bicycle rider under low light or nighttime conditions, and allowing approaching vehicles to clearly identify both the traveling rider and the distance from the riding subject without being blinded themselves by a light source emanating from the rider.

The “Portable LED Lighting Helmet To Illuminate A Cyclist Or A Subject While Riding Or Otherwise In Motion” provides this benefit with a partial ring of LED lights mounted to the bottom base of a standard, lightweight, impact resistant bicycle helmet. The ring of LED light bulbs almost fully encircles the bottom base of the helmet and each light provides a strong illumination downwards towards the rider and bicycle. Each LED light bulb is directionally positioned to provide direct illumination of the rider, bicycle, and ground below, and a lenses covering each LED light bulb provides the necessary amplification and magnification of the light beam to provide the maximum lighting coverage possible. There is a small break in the ring of LED lights towards the front bottom base of the helmet so as to prevent lighting glare to get in the way of providing clear vision forward to the rider.

The partial ring of lights along the base of the helmet are interconnected through circuitry that is driven by a small power supply of two (2) AAA batteries contained in the rear of the helmet. On the exterior rear of the helmet is located a small on/off switch to illuminate the LED light ring when desired.

In a second embodiment of the “Portable LED Lighting Helmet To Illuminate A Cyclist Or A Subject While Riding Or Otherwise In Motion”, the subject of this invention can also be applied to a motorcycle helmet to achieve the same benefit. The application of the LED light ring for the purpose of illuminating the motorcycle rider, motorcycle, and ground below remain identical, with slightly differing implementations depending on the type of motorcycle helmet.

For the case of motorcycle helmets that do not envelop the entire head area of the human subject, where the bottom base of the helmet ends above the top of the subject's ears, the application of this invention is identical to the bicycle helmet. That is, the ring of LED lights would be positioned along the bottom base of this style of motorcycle helmet, with the circuitry, DC/Batter power supply, and on/off switch as in the case of the Bicycle helmet embodiment.

For the case of motorcycle helmets that envelop the entire head area of the human subject, where the bottom of the helmet extends to the subject's shoulders and bottom of the neck area, a slightly altered application is necessary. A partial ring around the base of the helmet would be complemented with additional rows of LED lights placed partially along the exterior edge of the helmet, again, angled downwards for the purposes of illuminating the rider, the motorcycle, and the ground below. The basic circuitry, DC/battery power supply, and on/off switch would remain unchanged.

Finally in the last embodiment of the “Portable LED Lighting Helmet To Illuminate A Cyclist Or A Subject While Riding Or Otherwise In Motion” invention, this application provides for a detachable ring of LED lights that could be attached to a pre-existing bicycle helmet. This detachable LED light ring would be constructed in such a manner where each LED light bulb is mounted on a flexible strip with embedded circuitry, with an individual lens providing light beam amplification in the same manner as the first embodiment with the LED light ring integrated into the bicycle helmet. This flexible strip would at one end be attached to a small DC/battery power supply with an integrated on/off switch. The flexible, detachable LED light ring would be attachable to the base of a pre-existing helmet utilizing standard velcro enclosures, and once attached, the angle of placement of the LED lights would be such as to provide the widest possible downwards illumination of the rider, bicycle or motorcycle, and the ground below.

### BRIEF DESCRIPTION OF THE DRAWINGS

FIG. 1 A side, exterior view of the “Portable LED Lighting Helmet To Illuminate A Cyclist Or A Subject While Riding Or Otherwise In Motion” invention, depicting placement of the LED light ring.

FIG. 2 A cutaway side view of the “Portable LED Lighting Helmet To Illuminate A Cyclist Or A Subject While Riding Or Otherwise In Motion” invention depicting placement of the LED light ring.

FIG. 3 A bottom view of the “Portable LED Lighting Helmet To Illuminate A Cyclist Or A Subject While Riding Or Otherwise In Motion” invention, showing the partial ring of LED lights along the base of the helmet.

FIG. 4 A view of the “Portable LED Lighting Helmet To Illuminate A Cyclist Or A Subject While Riding Or Otherwise In Motion” invention with the helmet being worn by a cyclist in motion, clearly showing the self-illumination characteristics.

FIG. 5 A view of the detachable LED light ring that can be mounted on a pre-existing helmet.

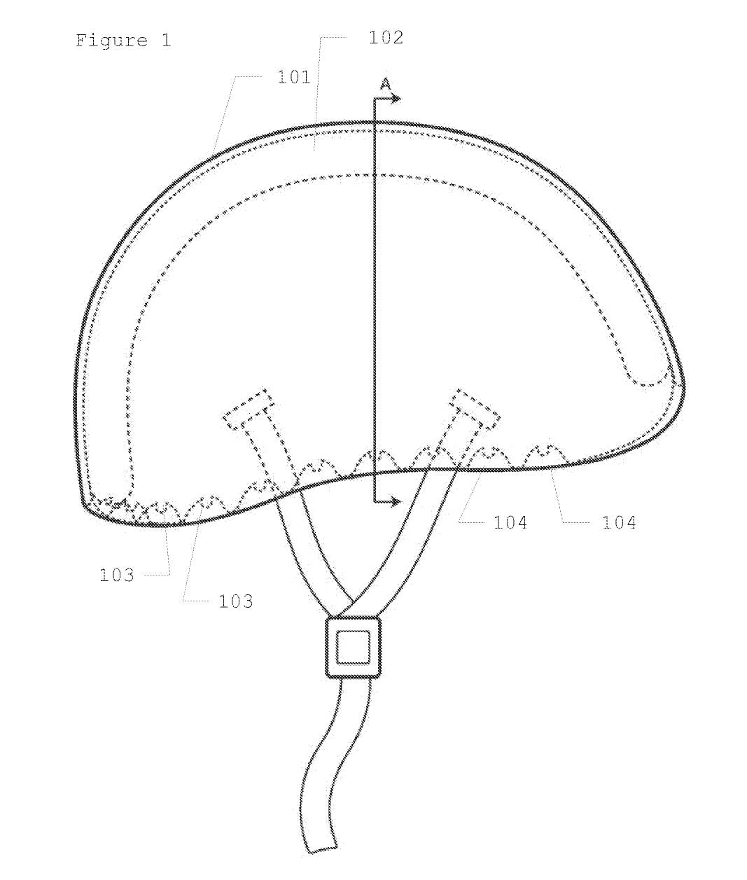

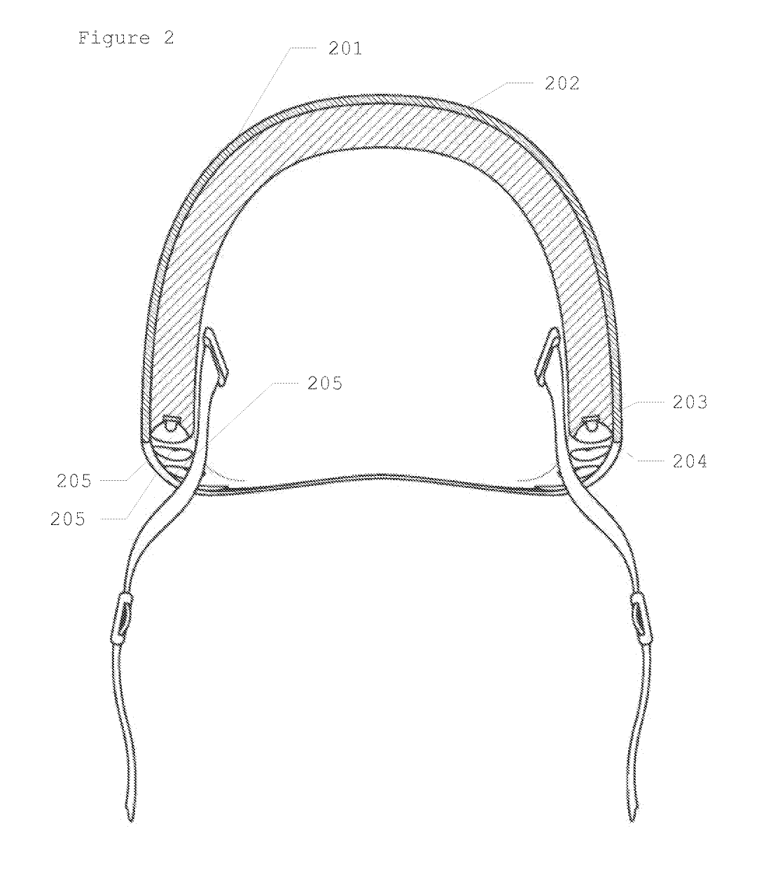

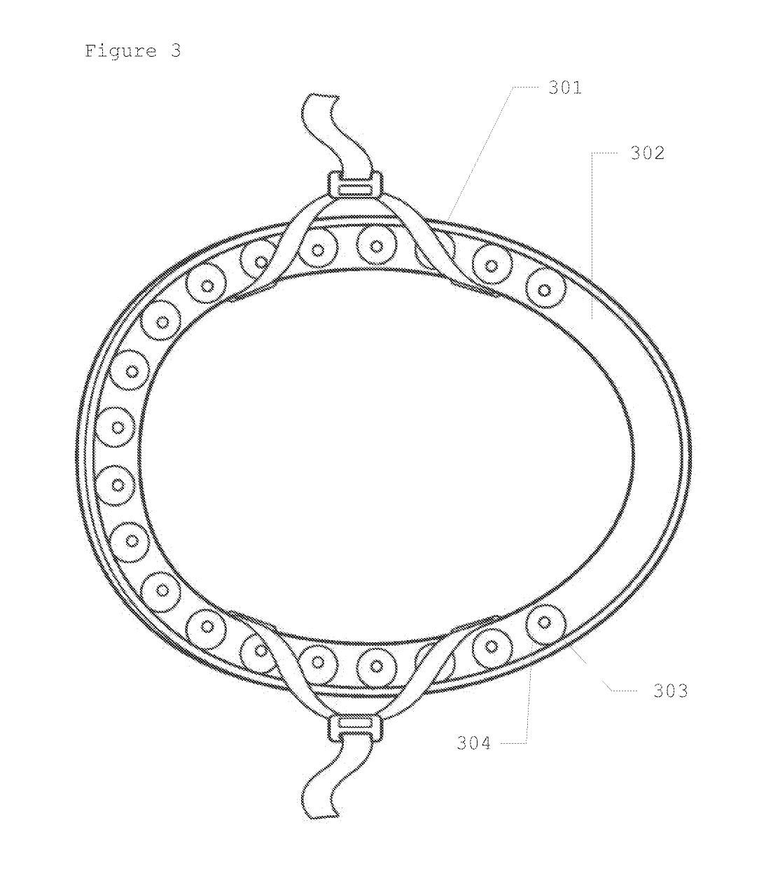

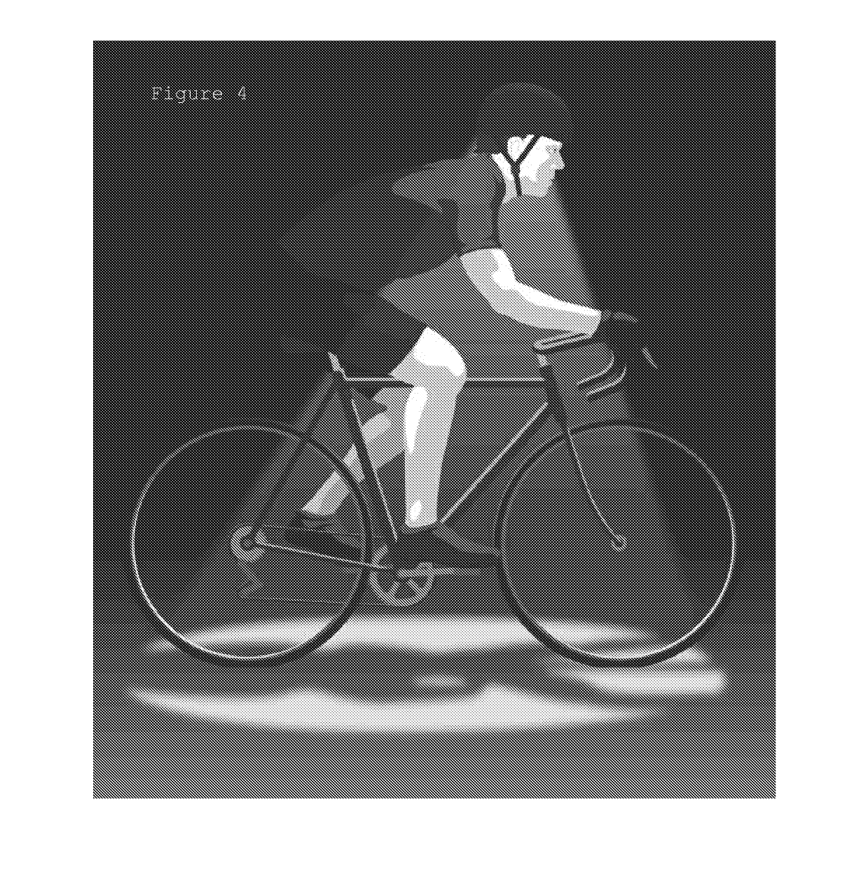

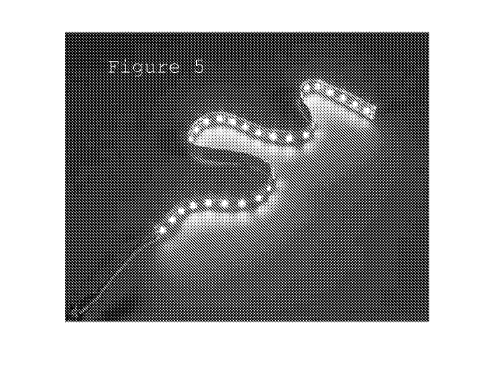

### DETAILED DESCRIPTION OF THE INVENTION

<FIG. 1> shows a side view of the “Portable LED Lighting Helmet To Illuminate A Cyclist Or A Subject While Riding Or Otherwise In Motion” invention that is the subject of this application. 101 shows the exterior hard shell of the helmet, and 102 shows an outline of the padded foam mounted on the interior of the helmet for protection of the human subject's head area. Multiple points 103 show the individual LED light bulbs mounted on the bottom base of the helmet, and with multiple points 104 showing the lens that serve to amplify and magnify the diameter of the light beam as it illuminates the rider, the bicycle, and the ground below.

<FIG. 2> shows a cutaway side view of the “Portable LED Lighting Helmet To Illuminate A Cyclist Or A Subject While Riding Or Otherwise In Motion”, shown at the cutaway point “A” depicted in <FIG. 1> In this diagram, 201 shows the exterior hard shell of the helmet, and 202 shows the soft foam head protection padding mounted on the interior of the helmet. An individual LED light bulb 203 and LED lens 204 is visible in this cutaway view, and additional LED bulbs and lenses are visible in multiple points 205.

<FIG. 3> shows a bottom view of the “Portable LED Lighting Helmet To Illuminate A Cyclist Or A Subject While Riding Or Otherwise In Motion” invention. 301 again shows the hard exterior shell of the helmet, and 302 the soft interior head protection padding. Individual LED light bulbs are visible at 303, with the lens covering shown in 304. Note that in this bottom view the portion corresponding to the right edge of the diagram does not contain a full ring of LED lights. This portion corresponds to the front of the helmet as the helmet is worn by a human subject, and the break in the LED ring prevents glare that may result from having the illumination pass directly in front of or into the human subject's eyes.

<FIG. 4> shows a complete depiction of the “Portable LED Lighting Helmet To Illuminate A Cyclist Or A Subject While Riding Or Otherwise In Motion” invention being worn by a cyclist in motion. In this diagram, it can be clearly seen that the rider, the bicycle, and the ground below are brightly illuminated to provide for a complete visual identification of the rider in low or nighttime lighting conditions by approaching vehicles or other human subjects. Note that there is a break in the circle of light towards the front of the helmet, as mentioned in the description for <FIG. 3>, so as not to blind the rider while wearing the helmet.

<FIG. 5> depicts the flexible, detachable, ring of LED lights that can be attached manually to the bottom base of an existing bicycle helmet. The flexible light ring would be attached to the helmet base using standard velcro enclosures, and the wiring necessary to drive the illumination is clearly visible.

What is claimed is:

1: This invention (hereinafter known as a “Portable LED Lighting Helmet To Illuminate A Cyclist Or A Subject While Riding Or Otherwise In Motion”) provides for a partial ring of LED lights integrated into the bottom base surface of a bicycle helmet that, when on, provides a bright illumination directed downwards away from the bottom base of the helmet. In this configuration, when the helmet is worn by a bicycle rider, the downwards direction of the light produced by the partial LED light ring serves to brightly illuminate the rider, the bicycle, and the ground below in low light or nighttime conditions. The light thus produced by this invention serves to illuminate not forwards or backwards but the moving subject itself and directly, making the moving subject highly visible to approaching vehicles or other moving subjects. The bicycle helmet will also be of sufficient light weight to be worn during walking of a human subject, thereby providing the same illumination benefit as for the bicycle rider.

2: In a specific embodiment of the “Portable LED Lighting Helmet To Illuminate A Cyclist Or A Subject While Riding Or Otherwise In Motion” in claim 1, this invention can provide for a helmet applicable towards a motorcycle rider for the same type of illumination benefit.

3: In a separate embodiment of the “Portable LED Lighting Helmet To Illuminate A Cyclist Or A Subject While Riding Or Otherwise In Motion” in claim 1, this invention also provides for a detachable, portable strip of LED lights that can be attached to any helmet or headgear apparatus to provide the same type of illumination benefit.
